(19) United States
(12) Patent Application Publication
(10) Pub. No.: US 2009/0089095 A1
(43) Pub. Date: Apr. 2, 2009

(54) Clinical Information Acquisition and Processing System

(75) Inventors: Matthew Paul Esham, Pennsville, NJ (US); Jeffrey Granito, Phoenixville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/028,375

(22) Filed: Feb. 8, 2008

Related U.S. Application Data
(60) Provisional application No. 60/976,571, filed on Oct. 1, 2007.

(51) Int. Cl. G06Q 50/00

(52) U.S. Cl. 705/3

(57) ABSTRACT

A system for acquiring and processing data for use by a clinical information system includes an interface processor for automatically receiving patient clinical data from multiple different sources. The interface processor parses clinical data received from an individual source to identify data elements indicating clinical data type as well as an associated time, stage, value and unit of measure. An adaptive data processor automatically adaptively processes the clinical data received from the individual source to provide processed clinical data accommodating absence of a value of at least one of the data elements by substituting at least one of, (a) a null value, (b) a zero value and (c) a default value for an absent data element. A storage processor stores the processed clinical data in a repository and retrieves a selectable plurality of the data elements for reproduction in an adaptively selectable presentation.

This is a non-provisional application of provisional application Ser. No. 60/976,571 filed Oct. 1, 2007, by M. Esham et al.

### FIELD OF THE INVENTION

This invention concerns a system for acquiring and processing clinical data by, type, an associated time, stage, value and unit of measure for storage and retrieval as well as reproduction in an adaptively selectable presentation, for example.

### BACKGROUND OF THE INVENTION

Clinical information and imaging modality systems (e.g., MRI, CT, X-ray, Ultrasound systems) include data acquisition systems and interfaces that communicate clinical data in different formats. Known systems for processing clinical data typically require hard coded data mapping functions for translating data between different formats suitable for different interfaces employed by different devices, versions of a device and manufacturers. In order to support different first and second system interfaces to a Clinical Information System, known systems require two separate, discrete interfaces, for example.

These separate, non flexible interfaces burden known systems with a high level of overhead code that needs to be maintained. The known system interfaces are also usually part of a compiled software application (e.g., Clinical Information System). This means changes to update an interface involve the often difficult task of fixing a core Clinical Information System application. A system according to invention principles addresses these deficiencies and related problems.

### SUMMARY OF THE INVENTION

A system acquires data that may be parsed from different systems and structures the data into logical tables based on time, anatomical site, or a stage at which the data was collected. A system for acquiring and processing data for use by a clinical information system includes an interface processor for automatically receiving patient clinical data from multiple different sources. The interface processor parses clinical data received from an individual source to identify data elements indicating clinical data type as well as an associated time, stage, value and unit of measure. An adaptive data processor automatically adaptively processes the clinical data received from the individual source to provide processed clinical data accommodating absence of a value of at least one of the data elements by substituting at least one of, (a) a null value, (b) a zero value and (c) a default value for an absent data element. A storage processor stores the processed clinical data in a repository and retrieves a selectable plurality of the data elements for reproduction in an adaptively selectable presentation.

### BRIEF DESCRIPTION OF THE DRAWING

FIG. 1 shows an overview of a system for acquiring and processing data for use by a clinical information system, according to invention principles.

FIG. 2 shows a system for acquiring and processing data for use by a clinical information system, according to invention principles.

FIG. 3 shows a data node structure to which source data is mapped, according to invention principles.

FIG. 4 shows a further data node structure to which source data is mapped, according to invention principles.

FIGS. 5, 6 and 7 show a data node structure to which stage, time, type, value, UOM (unit of measure) and sort data is mapped, according to invention principles.

FIG. 8 shows a flowchart of a process performed by a system for acquiring and processing data for use by a clinical information system, according to invention principles.

### DETAILED DESCRIPTION OF THE INVENTION

A system incorporates an interface module that maps data acquired from a source system and structures it into user readable tables. The system creates a generic data structure using xml, for example, enabling creation of multiple views of data for display in multiple different formats in response to user configuration data. In addition, the system isolates an interface module from data structure changes and is readily updated to handle new, different, and or updated interface data and data structures. The system adapts to, and accommodates, new or different interface data by storing the data into a structure that advantageously accepts data from multiple different systems that communicate data in a format which may be parsed. The system further creates a view of medical data, for example, based on time, site and or stage. In addition, a user may choose a format in which to view data such as in a time based, site based, or stage based view.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

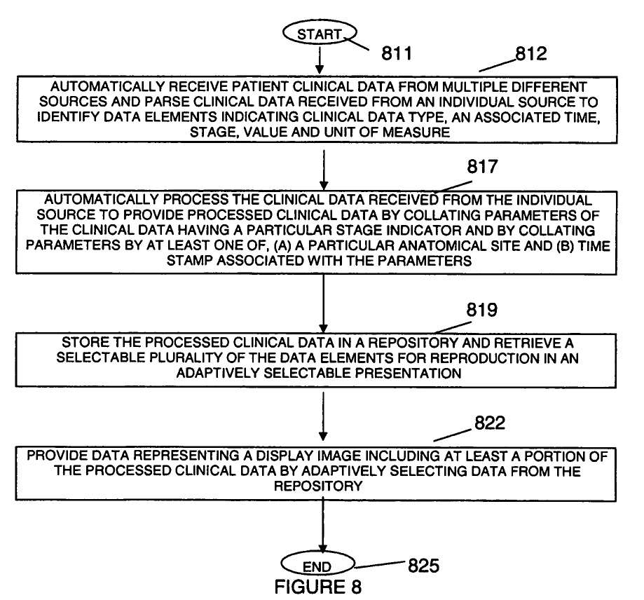

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 8) herein may be performed automatically or wholly or partially in response to user command. An activity (including a step) performed automatically is performed in response to executable instruction or device operation without user direct initiation of the activity. An object or data object comprises a grouping of data, executable instructions or a combination of both or an executable procedure. Further, a document or record comprises a compilation of data in electronic form and is the equivalent of a paper document and may comprise a single, self-contained unit of information.

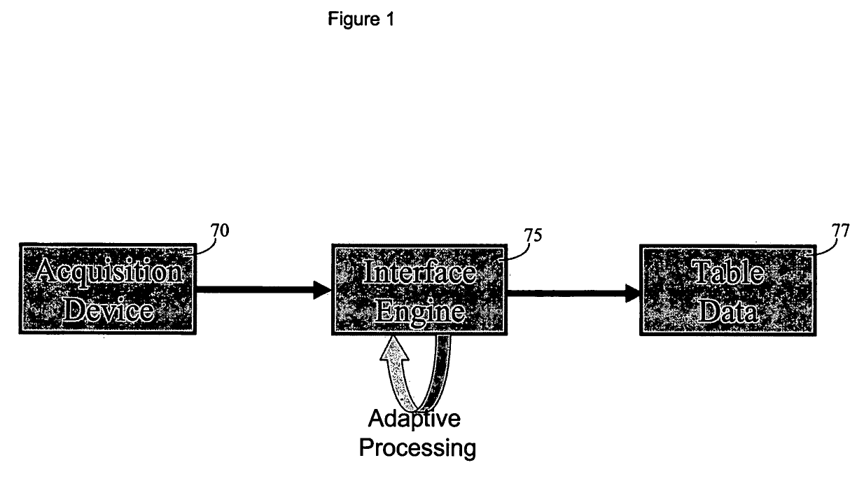

FIG. 1 shows an overview of a system for acquiring and processing data for use by a clinical information system. Acquisition device 70 receives clinical data from different sources including imaging modality and patient monitoring devices (such as MRI, CT scan, X-ray, Ultrasound, ECG and Catheterization devices) and provides processed acquired data to interface engine 75. Engine 75 parses, adaptively processes and structures the acquired data and incorporates the structured data into logical tables 77.

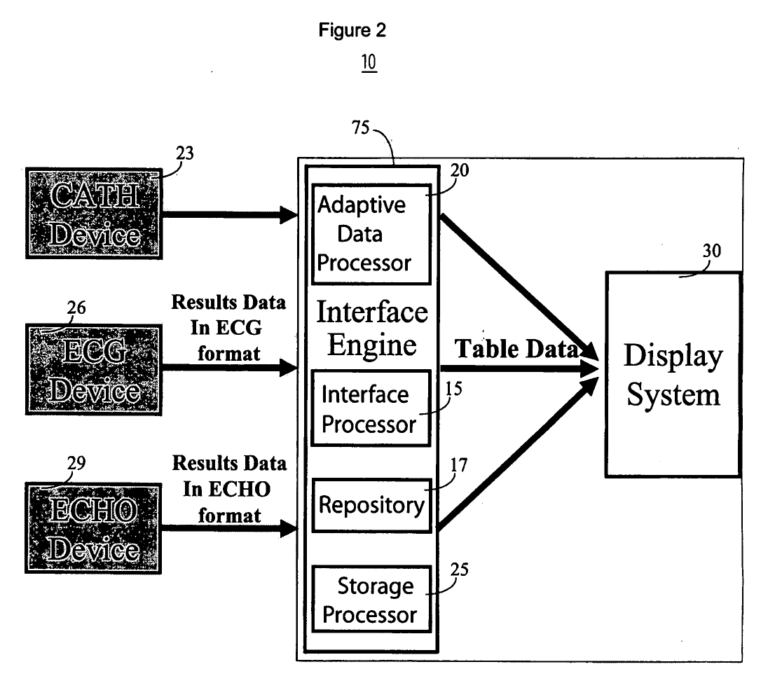

FIG. 2 shows system 10 for acquiring and processing data for use by a clinical information system. System 10 includes imaging modality and patient monitoring devices 23, 26 and 29, interface engine 75 incorporating interface processor 15, acquisition data processor 20, storage processor 25, storage repository 17 and display system (display processor) 30. Interface processor 15 automatically receives patient clinical data from different sources 23, 26 and 29, for example. Processor 15 parses clinical data received from an individual source to identify data elements indicating clinical data type, an associated time, stage, value and unit of measure. Adaptive data processor 20 automatically adaptively processes the clinical data received from the individual source to provide processed clinical data accommodating absence of a value of at least one of the data elements by substituting at least one of, (a) a null value, (b) a zero value and (c) a default value for an absent data element. Storage processor 25 stores the processed clinical data in table structure 77 (FIG. 1), for example, in repository 17 (FIG. 2) and retrieves a selectable plurality of the data elements for reproduction in an adaptively selectable presentation.

A node structure for each type of data table stored in table structure 77 is created to support, time, site and stage related patient medical data. Imaging modality and patient monitoring device data received by interface processor 15 is parsed and mapped by adaptive data processor 20 into table nodes in e.g., HTML or XML language format tables. Further, HTML table data is provided to display processor 30 for display as a read only HTML table, for example, in an adaptively selectable presentation. Adaptive data processor 20 automatically adaptively processes the clinical data received from an individual source by incorporating a predetermined or default value into a patient clinical parameter attribute. A clinical parameter attribute comprises, Stage (e.g., cancer stage, data processing stage or stage in a treatment procedure when data is collected or medical condition stage), Time (e.g., time of parameter acquisition), Type (parameter type e.g., CO carbon monoxide), Value, UOM (Unit of Measure) and Sort (configured sort order of a column of parameter data). Adaptive data processor 20 performs sort adaptive processing to determine column order of parameter attribute data by ordering column data based on a configured sort order of a column.

Adaptive data processor 20 may append a stage indicator to outbound data provided by acquisition device 23, 26 or 29 that is missing such a stage indicator, in response to predetermined configuration data to adapt acquisition device data to be compatible with desired interface requirements. Similarly, adaptive data processor 20 may append a UOM or anatomical site indicator to outbound data provided by acquisition device 23, 26 or 29 that is missing such indicators, in response to predetermined configuration data to adapt acquisition device data to be compatible with desired interface requirements.

Interface processor 15 may receive a clinical parameter having a null value for clinical parameter value, UOM and anatomical site and storage processor 25 stores a null value in a corresponding node structure stage node. Display processor 30 displays a corresponding blank value, if desired, for these null value attributes in an image presented on a workstation. Interface processor 15 also acquires clinical parameter value pairs (Type=Name:Value=Value, Site=Name:Value=Value) and complex data values sent as one, two, or three measurements associated with a stage or acquisition time (e.g., Cardiac measurements for hemodynamics and pressures commonly have a Systolic, Mean, and Diastolic or other triple value data set).

Adaptive data processor 20 also merges multiple rows of clinical parameter data for a particular stage and/or based on time stamp and display processor 30 presents the stage data in multiple columns of one row and presents data collated by time stamp or stage for multiple stages of data acquired. Regardless of the type of inbound data set acquired by interface processor 15, system 10 adapts display format provided by display processor 30 in response to user requirements.

In exemplary operation, interface processor 15 acquires clinical parameter data comprising, Stage=Pre, Time=12:01, Type=CO, Value=4.0, UOM=L/m, Sort=1 for processing and storage in structured data format in repository 17. Adaptive data processor 20 automatically maps the acquired data to nodes in a node structure of an adaptive table stored in repository 17 and the acquired data is stored in the table by storage processor 25. Further, storage processor 25 retrieves a selectable set of data elements from the table in repository 17 for reproduction in an adaptively selectable presentation by display processor 30.

Storage processor 25, operating in conjunction with display processor 30, build a display table by adaptively selecting data from the table in repository 17 based on the time data:

| Time | Stage | CO |
|---|---|---|
| 12:01 | Pre | 4.0 L/m |

Storage processor 25, with display processor 30, builds a display table by adaptively selecting data from the table in repository 17 based on the time data but without stage data:

| Time | CO |
|---|---|
| 12:01 | 4.0 L/m |

If a source system does not support sending stage data, but a stage is desired, adaptive processor 20 appends a default stage value in response to predetermined configuration data:

| Time | Stage | CO |
|---|---|---|
| 12:01 | Cath | 4.0 L/m |

Although the data displayed is specific cardiac hemodynamic data, the adaptive table structure in repository 17 enables adaptive processor 20 to adaptively process acquired data that may originate from new or unknown data sets generated subsequent to creation of system 10, for example.

In further exemplary operation, interface processor 15 acquires clinical parameter data comprising, Stage=Pre, Time=12:01, Type=CO, Value=4.0, UOM=L/m, Sort=1 for storage in a first data structure node and Stage=Pre, Time=12:02, Type=O2, Value=98, UOM=%, Sort=2, for storage in a second data structure node, in structured data format in repository 17. Adaptive data processor 20 automatically maps the acquired data to the first and second nodes in the node structure of an adaptive table stored in repository 17 for storage in the table by storage processor 25. Further, storage processor 25 retrieves a selectable set of data elements from the table in repository 17 for reproduction in an adaptively selectable presentation by display processor 30. Storage processor 25, operating in conjunction with display processor 30, builds a display table by adaptively selecting data from the table in repository 17 based on the time data:

| Stage | CO | O2 |
|---|---|---|
| Pre | 4.0 L/m | 98% |

In the displayed table the time data is ignored and the data is merged into a single row as both data sets are from the same stage. Adaptive processor 20 may adaptively process the data stored in the first and second nodes to produce a variety of different display table formats that omit or include selected different elements in the nodes. Adaptive processor 20 adaptively processes table data stored in repository 17 to incorporate UOM (Unit of Measure) indicators (and other default clinical parameter attributes) for acquired data provided by data sources (e.g., of particular device manufacturers) that fail to provide UOM indicators or other attributes. This supports providing a consistent interface for different devices, and different versions of a device made by one manufacturer and consistent data for presentation and communication. This also enables adaptive processor 20 and display processor 30 to display data in an optimum format to a user, including a UOM indicator, for example.

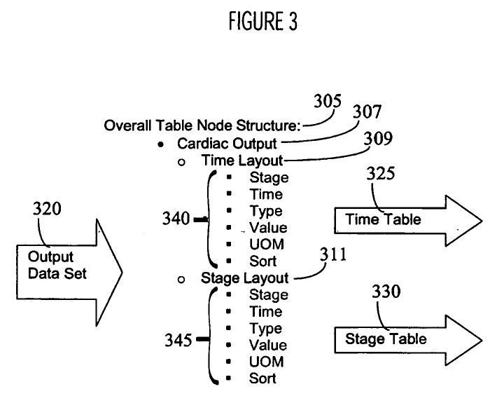

FIG. 3 shows a data node structure to which source data is mapped. Specifically, system 10 (FIG. 2) employs an xml node structure in repository 17 to which source data acquired by interface processor 15 is mapped. Interface processor 15 operating in conjunction with adaptive data processor 20 maps the same acquired data set 320 (FIG. 3) to different sets of table nodes 340 and 345 (each set including clinical parameter attributes Stage, Time, Type, Value, UOM and Sort) respectively. Different sets of table nodes 340 and 345 are included in a Cardiac output section 307 of an overall table node structure 305. Specifically, sets of table nodes 340 and 345 are included in time layout 309 and stage layout 311 sections of the table node structure. Units 15 and 20 may add different default values to missing values of parameter attributes in sets of table nodes 340 and 345 and adapt the table data to support a user desired display layout. The different sets of table nodes 340 and 345 are used to create an output table for display. Adaptive processor 20 with display processor 30 processes sets of table nodes 340 and 345 to provide 325 a time based table and provide 330 a stage based table.

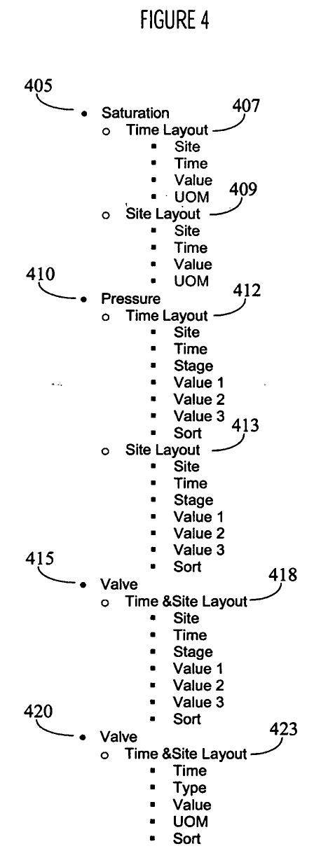

FIG. 4 shows a further data node structure to which source data is mapped by interface processor 15 (FIG. 2) operating in conjunction with adaptive data processor 20. Parameter attribute sets are stored for parameters blood oxygen saturation 405, blood pressure 410, valve data 415 and different valve data 420. Different sets of blood oxygen saturation 405 table node data 407 and 409 are provided for a time and anatomical site output format and display layout provided by system 10. Table node data sets 407 and 409 include site, time, value and UOM attributes. Similarly, different sets of blood pressure 410 table node data 412 and 413 are provided for a time and anatomical site output format and display layout. A set of valve 415 table node data 418 is provided for a time and anatomical site output format and display layout by display processor 30 and a further set of different valve 420 table node data 423 is provided for a time and anatomical site output format and display layout.

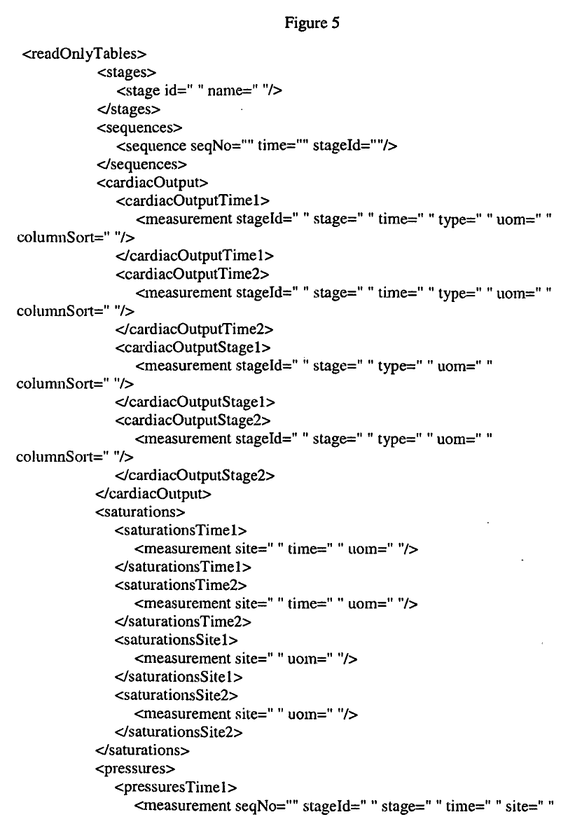

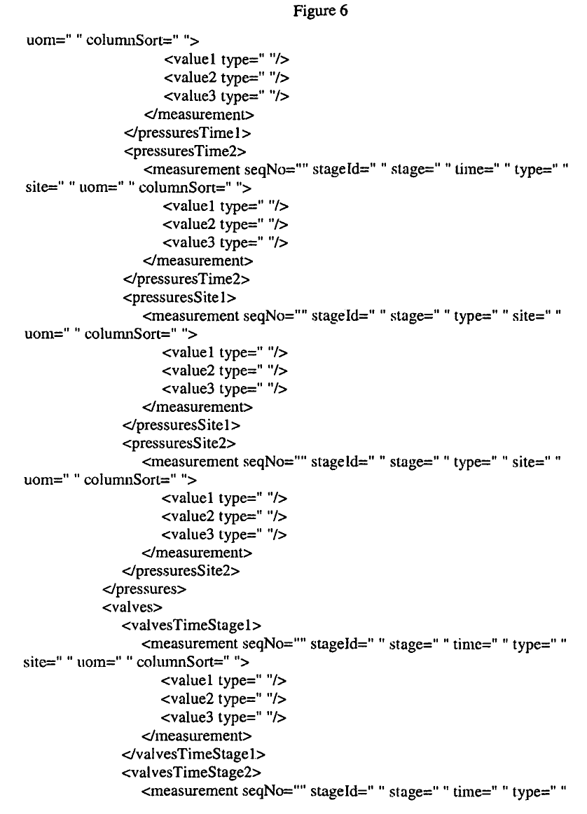

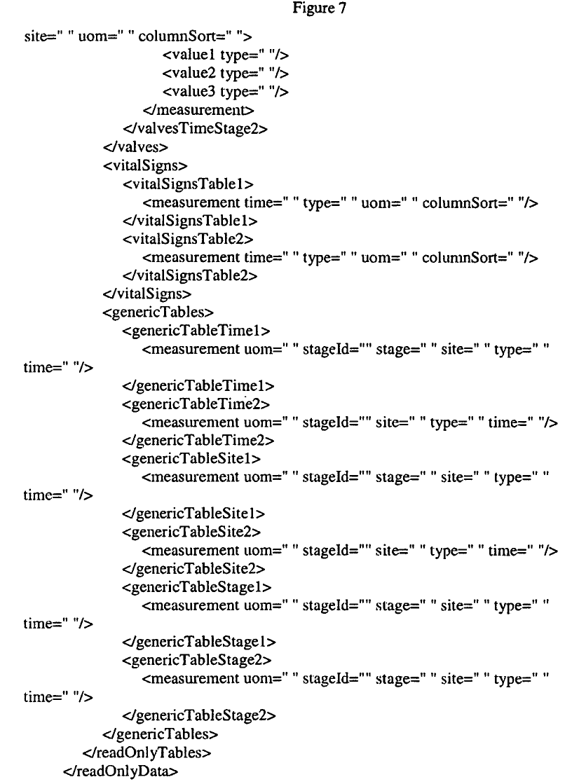

FIGS. 5. 6 and 7 illustrate a generic data node structure, stored in one or more tables in repository 17 (FIG. 2), to which stage, time, type, value, UOM (unit of measure) and sort data is mapped. FIG. 5, 6, 7 comprise a master xml node structure which determines the node contents of possible tables. This node structure determines the contextual data contents and a mechanism of display. FIGS. 5, 6 and 7 display the xml data nodes referenced in FIG. 4, which define the UI layout of the dataset based on how the data is mapped to a node. The xml data structure defined in FIGS. 5, 6, 7, allow the system to take a data set and build a display based on the needed context. This allows the dataset to be a level of abstraction away from the display, which allows for a single dataset to be displayed in a multitude of display formats while not forcing the source system to support any of those mechanisms. The generic node structure allows source system 23, 26 and 29 to send time, site, or stage collated data to interface processor 15 of a receiving system and have it redisplayed by display processor 30 in a logical format. System 10 isolates the changes to the mapping of data into the node structure, such that it is easy to make changes over time, and or consume any new site, time, or stage based data in the future. The system is advantageously acquisition system non-specific. The system enables data to be captured from a wide variety of source system data formats that may be parsed and enables system 10 to support multiple source system implementations. The system may be used by applications which can receive data from an acquisition system, and needs to redisplay it.

FIG. 8 shows a flowchart of a process performed by system 10 for acquiring and processing data for use by a clinical information system. In step 812 following the start at step 811, interface processor 15 automatically receives patient clinical data from multiple different sources and parses clinical data received from an individual source to identify data elements indicating clinical data type, an associated time, stage, value, unit of measure, sort value and an anatomical site. The stage comprises at least one of, (a) a data processing stage, (b) a stage in a treatment procedure when data is collected and (c) a medical condition stage and the associated time is a time indicating time of acquisition of a clinical data parameter of a patient.

In step 817, adaptive data processor 20 automatically processes the clinical data received from the individual source to provide processed clinical data by collating parameters of the clinical data having a particular stage indicator and by collating parameters by at least one of, (a) a particular anatomical site and (b) time stamp associated with the parameters. Adaptive data processor 20 further automatically adaptively processes the clinical data received from the individual source by identifying and accommodating an absence of a value of at least one of the data elements by substituting at least one of, (i) a null value, (ii) a zero value and (iii) a default value for an absent data element. Adaptive data processor 20 performs sorting to determine column order (e.g., sequence of data elements in a horizontal row) of parameter attribute data by ordering column data based on a pre-configured sort order of a column. Processor 20 further associates a stage indicator, a Unit of Measure indicator and/or an anatomical site indicator, with the clinical data received from the individual source in response to predetermined configuration data to adapt acquisition device data to be compatible with desired interface requirements.

Storage processor 25, in step 819 stores the processed clinical data in repository 17 and retrieves a selectable plurality of the data elements for reproduction in an adaptively selectable presentation. Storage processor 25 stores the processed clinical data by mapping the processed clinical data to nodes in a node structure of a table stored in repository 17. In step 822, display processor 30 provides data representing a display image including at least a portion of the processed clinical data by adaptively selecting data from repository 17 and by collating parameters of the clinical data based on anatomical site and/or having a particular stage (for multiple stages of data acquired), and/or by timestamp (e.g. by time), into multiple columns of one row. The collated parameters of the clinical data are also provided in an adaptively structured data format provided by processor 20 for communication to a destination system by a communication processor (not shown to preserve drawing clarity) in interface engine 75 (FIG. 2). Display processor 30 adapts display format by providing data representing a display image including at least a portion of the processed clinical data by adaptively selecting data from repository 17 in response to user requirements independent of the type of received patient clinical data. The process of FIG. 8 terminates at step 825.

The systems and processes of FIGS. 1-8 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Specifically, the system is usable to take data from multiple acquisition systems and display it at a destination system as a structured data table. The processes and applications may in alternative embodiments, be located on one or more (e.g., distributed) processing devices accessing a network linking the elements of FIG. 2. Further, any of the functions and steps provided in FIGS. 1-8 may be implemented in hardware, software or a combination of both and may reside on one or more processing devices located at any location of a network linking the elements of FIG. 2 or another linked network including the Internet.

What is claimed is:

1. A system for acquiring and processing data for use by a clinical information system, comprising:
an interface processor for automatically receiving patient clinical data from a plurality of different sources and for parsing clinical data received from an individual source to identify data elements indicating clinical data type, an associated time, stage, value and unit of measure;
an adaptive data processor for automatically adaptively processing said clinical data received from said individual source to provide processed clinical data accommodating absence of a value of at least one of said data elements by substituting at least one of, (a) a null value, (b) a zero value and (c) a default value for an absent data element; and
a storage processor for storing said processed clinical data in a repository and retrieving a selectable plurality of said data elements for reproduction in an adaptively selectable presentation.

2. A system according to claim 1, wherein
said stage comprises at least one of, (a) a data processing stage, (b) a stage in a treatment procedure when data is collected and (c) a medical condition stage and
said time is a time indicating time of acquisition of a clinical data parameter of a patient.

3. A system according to claim 1, wherein
said data elements include a sort value.

4. A system according to claim 1, wherein
said data elements include an anatomical site.

5. A system according to claim 1, including
a display processor for providing data representing a display image by adaptively selecting data from said repository collated based on at least one of. (a) time and (b) stage.

6. A system according to claim 1, including
a display processor for providing data representing a display image including said processed clinical data by adaptively selecting data from said repository collated based on anatomical site.

7. A system according to claim 1, wherein
said adaptive data processor performs sorting to determine column order of parameter attribute data by ordering column data based on a pre-configured sort order of a column.

8. A system according to claim 1, wherein
said adaptive data processor associates a stage indicator with said clinical data received from said individual source in response to predetermined configuration data to adapt acquisition device data to be compatible with desired interface requirements.

9. A system according to claim 1, wherein
said adaptive data processor associates a Unit of Measure indicator with said clinical data received from said individual source in response to predetermined configuration data to adapt acquisition device data to be compatible with desired interface requirements.

10. A system according to claim 1, wherein
said adaptive data processor associates an anatomical site indicator with said clinical data received from said individual source in response to predetermined configuration data to adapt acquisition device data to be compatible with desired interface requirements.

11. A system for acquiring and processing data for use by a clinical information system, comprising:
an interface processor for automatically receiving patient clinical data from a plurality of different sources and for parsing clinical data received from an individual source to identify data elements indicating clinical data type, an associated time, stage, value and unit of measure;
an adaptive data processor for automatically processing said clinical data received from said individual source to provide processed clinical data by collating parameters of said clinical data having a particular stage indicator and by identifying an absence of a value of at least one of said data elements by substituting at least one of, (a) a null value, (b) a zero value and (c) a default value for an absent data element;
a storage processor for storing said processed clinical data in a repository and retrieving a selectable plurality of said data elements for reproduction in an adaptively selectable presentation; and
a display processor for providing data representing a display image including at least a portion of said processed clinical data by adaptively selecting data from said repository.

12. A system according to claim 11, wherein
said adaptive data processor automatically processes said clinical data received from said individual source to provide processed clinical data by collating parameters of said clinical data based on time stamp associated with said parameters.

13. A system according to claim 11, wherein
said display processor provides data representing a display image including processed clinical data by collating parameters of said clinical data having a particular stage into multiple columns of one row.

14. A system according to claim 11, wherein
said display processor provides data representing a display image including processed clinical data by collating parameters of said clinical data by time stamp or stage for multiple stages of data acquired.

15. A system according to claim 11, wherein
said display processor adapts display format by providing data representing a display image including at least a portion of said processed clinical data by adaptively selecting data from said repository in response to user requirements independent of the type of received patient clinical data.

16. A system according to claim 11, wherein
said storage processor stores said processed clinical data by mapping said processed clinical data to nodes in a node structure of a table stored in a repository.

17. A system for acquiring and processing data for use by a clinical information system, comprising:
an interface processor for automatically receiving patient clinical data from a plurality of different sources and for parsing clinical data received from an individual source to identify data elements indicating clinical data type, an associated time, stage, value and unit of measure;
an adaptive data processor for automatically processing said clinical data received from said individual source to provide processed clinical data by collating parameters of said clinical data having a particular stage indicator and by collating parameters by at least one of, (a) a particular anatomical site and (b) time stamp associated with said parameters;
a storage processor for storing said processed clinical data in a repository and retrieving a selectable plurality of said data elements for reproduction in an adaptively selectable presentation; and
a display processor for providing data representing a display image including at least a portion of said processed clinical data by adaptively selecting data from said repository.

18. A system according to claim 17, wherein
said adaptive data processor automatically processes said clinical data received from said individual source by identifying an absence of a value of at least one of said data elements by substituting at least one of, (a) a null value, (b) a zero value and (c) a default value for an absent data element.
